(19) United States
(12) Patent Application Publication
(10) Pub. No.: US 2011/0301785 A1
(43) Pub. Date: Dec. 8, 2011

(54) BIOLOGICALLY INSPIRED COMPLIANT LOCOMOTION FOR REMOTE VEHICLES

(76) Inventor: Lee F. Sword, Hollis, NH (US)

(21) Appl. No.: 13/042,409

(22) Filed: Mar. 7, 2011

Related U.S. Application Data
(60) Provisional application No. 61/310,854, filed on Mar. 5, 2010.

(51) Int. Cl. B62D 55/116

(52) U.S. Cl. 701/2; 280/5.5

(57) ABSTRACT

A method for providing a uniform ground contact pressure when operating a tracked remote vehicle comprises: sensing the terrain below the remote vehicle using a series of proximity sensors that are configured to measure a distance from an underside of a chassis of the remote vehicle to the terrain directly beside a track of the remote vehicle; monitoring, mapping, and classifying an upcoming terrain; and adapting the remote vehicle's track profile, flipper position, arm position, and center of balance based on the upcoming terrain.

### INTRODUCTION

This application claims priority to U.S. Provisional Patent Application No. 61/310,854, filed Mar. 5, 2010, titled Biologically Inspired Compliant Locomotion for Tracked Robots.

The present teachings relate to increasing the mobility capabilities of a remote vehicle. The present teachings relate more specifically to utilizing biologically-inspired compliant locomotion to increase mobility capabilities of tracked remote vehicles.

### BACKGROUND

Existing remote vehicles have demonstrated difficulties with terrain including, for example, a mixture of soil (or sand) and rocks similar to the inclined banks of a southwestern US dessert arroyo. For example, currently fielded remote vehicles such as the iRobot® PackBot® and the Foster-Miller® Talon® have demonstrated that unsuspended tracks can at times result in less than ideal mobility performance in rough terrain. Some features of the iRobot® PackBot® are shown and described in U.S. Pat. No. 7,597,162, issued Oct. 6, 2009, titled Robotic Platform, and U.S. Pat. No. 7,654,348, issued Feb. 2, 2010, titled Maneuvering Robotic Vehicles Having a Positionable Sensor Head, the disclosure of both of these patents being incorporated by reference herein in their entireties.

### SUMMARY

The present teachings provide a method for providing a uniform ground contact pressure when operating a tracked remote vehicle, comprising: sensing the terrain below the remote vehicle using a series of proximity sensors that are configured to measure a distance from an underside of a chassis of the remote vehicle to the terrain directly beside a track of the remote vehicle; monitoring, mapping, and classifying an upcoming terrain; and adapting the remote vehicle's track profile, flipper position, arm position, and center of balance based on the upcoming terrain.

The present teachings also provide a tracked remote vehicle configured to provide a uniform ground contact pressure when operating, the tracked remote vehicle comprising an active suspension system including one or more of active sensing with both reactive and predictive responses to the terrain, active bogie wheels, a center-of-gravity shifting payload or device, and independent autonomous flipper control.

The present teachings further provide a tracked remote vehicle configured to provide a uniform ground contact pressure when operating, the tracked remote vehicle comprising a passive suspension system to enhance track contact over uneven ground and including one or more of a suspended bogie wheels, a compliant bogie strip, jamming tracks, open track cells, and flap-cleated tracks.

Additional objects and advantages of the present teachings will be set forth in part in the description which follows, and in part will be obvious from the description, or may be learned by practice of the present teachings. The objects and advantages of the present teachings will be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate exemplary embodiments of the present teachings and together with the description, serve to explain the principles of the present teachings.

### BRIEF DESCRIPTION OF THE DRAWINGS

FIG. 1 is a schematic cross sectional side view of an embodiment of a remote vehicle in accordance with the present teachings.

FIG. 2 is a schematic cross sectional side view of another embodiment of a remote vehicle in accordance with the present teachings.

FIG. 3 is a side perspective view of a segment of a remote vehicle track having open cells in accordance with the present teachings.

FIG. 4 is a schematic cross sectional side view of another embodiment of a remote vehicle in accordance with the present teachings.

FIG. 5 is a schematic cross sectional side view of another embodiment of a remote vehicle in accordance with the present teachings.

FIG. 6 is a schematic cross sectional side view of another embodiment of a remote vehicle in accordance with the present teachings.

### DETAILED DESCRIPTION

Reference will now be made in detail to exemplary embodiments of the present teachings, examples of which are illustrated in the accompanying drawings.

Vehicle sinkage, and therefore motion resistance, depends on the maximum pressure exerted by the vehicle on the ground and not the nominal ground pressure. Therefore, in certain terrains it is important that tracked vehicles provide ground contact pressure that is as uniform as possible when operating. It is believed that more uniform ground pressure can improve remote vehicle mobility in a mixture of soil (or sand) and rocks similar to the inclined banks of a southwestern U.S. dessert arroyo. The present teachings contemplate methods for achieving more uniform ground pressure. An exemplary tracked remote vehicle, disclosed herein for explanatory purposes, is an iRobot® PackBot®; however, those skilled in the art will appreciate the applicability of the disclosed teachings to other tracked remote vehicles with a similar morphology in the same weight class as well as other weight classes.

Highly capable biologic locomotion inspires the mechanical devices and teachings set forth herein. Locomotion of centipedes and snails display a natural tendency toward terrain contouring and achieving the lowest possible ground pressure for given terrain conditions. In an effort to increase mobility capabilities of a remote vehicle such as an iRobot® PackBot®, the present teachings contemplate various embodiments that are directed to providing even ground pressure over the entire remote vehicle footprint. The present teachings contemplate both active and passive suspension systems. Passive suspension systems include, for example, a tank-like suspension such as suspended bogie wheels to enhance track contact over uneven ground, a compliant bogie strip, jamming tracks, open track cells, and flap-cleated tracks. Active suspension systems include, for example, control systems providing active sensing with both reactive and predictive responses to the terrain, active bogie wheels, a center-of-gravity shifting payload or device, independent autonomous flipper control.

### Suspended Bogie System

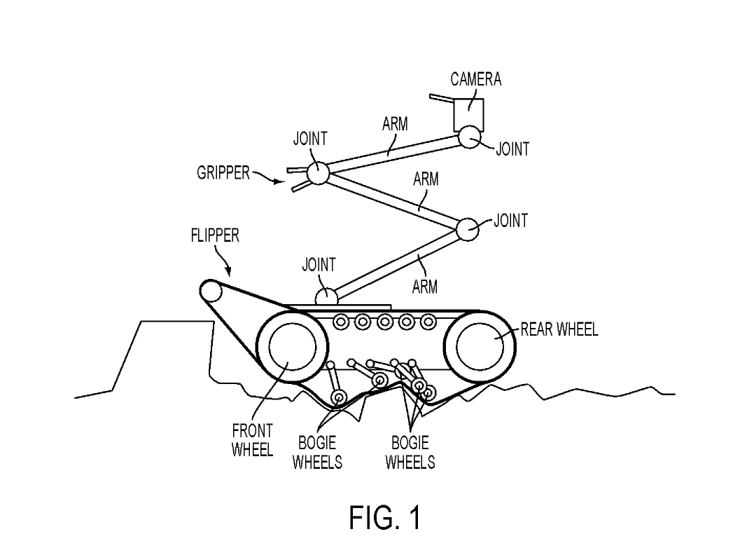

The most dramatic advancements in tracked vehicle suspension systems came during WWI and WWII on vehicles such as the M4 Sherman tank. The M4 Sherman tank uses a segmented track driven by a toothed drive hub at the front. Bogie wheels are attached to a spring damper system to allow for vertical travel of the bogie wheels, and thus the ability of the tracks to conform to underlying terrain. In contrast, a stock PackBot® system utilizes a continuous track mounted around compliant drive (rear) wheels and driven (front) wheels that provide impact protection. The present teachings contemplate the implementation of suspended bogie wheels on a tracked remote vehicle to provide improved track contact over uneven ground. A schematic diagram of a tracked remote vehicle having a passive, tank inspired, suspension system is shown in FIG. 1.

Implementation of a suspended bogie system as shown in FIG. 1 can require modification of an existing remote vehicle, for example modification of a sideplate of an existing iRobot® PackBot® to relocate the battery ports and add compliance to a rear idler wheel to maintain required track tension while allowing for terrain contouring. Each bogie wheel is preferably suspended by mechanical linkages with spring dampers to provide maximum travel and shock absorption.

### Compliant Bogie Strip

The present teachings alternatively or additionally contemplate an embodiment utilizing a compliant bogie strip that is similar to the linkage-suspended bogie wheels described above because it allows the remote vehicle track to contour the terrain. A compliant bogie strip can be implemented without the use of mechanical linkages, thus increasing the system robustness. Instead of suspending the bogie wheels via a system of mechanical linkages, the bogie wheels can be mounted on a compliant one-piece bogie strip engaging a bottom portion of the track. The material selection for the bogie strip and/or the structure of the bogie strip can determines the compliance, spring force, and damping of the tracks, because compliance, spring force, and damping are supplied by deformation of the bogie strip material. A compliant bogie strip provides a more organic suspension technology that is dependant on material properties and geometries to provide complex desired functionality. In certain embodiments of the present teachings, the bogie wheels can be mounted to the compliant bogie trip via mounting arms, and geometry of the mounting arms can also determine compliance of the bogie strip.

### Jamming Tracks

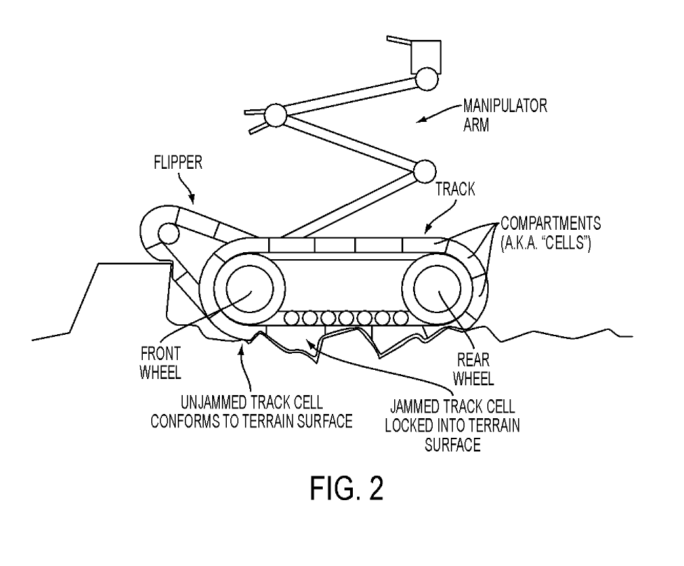

The present teachings contemplate additionally or alternatively utilizing a jamming material within the remote vehicle tracks to create a selectively compliant track system. Jamming material can be made to undergo reversible solid to liquid-like phase transitions, which can be referred to as jamming and unjamming. A track system, comprising multiple compartments filled with jamming material, can enable a compartment of the track to conform to the ground profile in an unjammed (liquid-like) state and then interlock with the ground when the compartment is jammed. Such a system could provide high surface area contact in addition to mechanical interlock with the ground. FIG. 2 shows conceptually what such a system would look like. In certain embodiments of the present teachings, a track surrounding the flipper also comprises one or more compartments containing jamming material.

In certain embodiments of the present teachings, the track compartments that house the jamming material can be substantially air-impermeable, although the composition of the track and its compartments can vary depending on a number of design factors including the type of jamming material contained in the compartments and economic considerations. Some of the jamming materials referred to below may be considered by certain people of skill in the art not truly undergo a “phase change.” Thus, the term “phase change materials” as used herein can comprise true phase change materials as well as material, as described herein and as would be appreciated by those skilled in the art, which behaves as if it undergoes a phase change.

The material comprising the compartment(s) should be at least minimally elastic or flexible. At least along a portion of the track engaging the ground, the material should have a strength (e.g., tear resistance) that is sufficient for carrying the remote vehicle across a variety of terrains. In accordance with various embodiments, the compartments can comprise, for example, a platinum-cure or tin-cure silicone based rubber or a Kevlar composite. Kevlar can provide strength against puncturing and can be combined with a more elastic material to attain a desired flexibility for the compartment(s). Platinum-cure or tin-cure RTV (room temperature vulcanizing) silicone based rubbers can be desirable because they are easily molded into custom shapes.

The present teachings contemplate utilizing a high-friction material for the tracks comprising, for example, soft elastomeric materials that can stretch and fold to maintain maximum surface area contact with the ground so that the friction (compressive) force applies over a large surface contact area. The high-friction material can also or alternatively comprise a material whose surface has bumps or a dense array of tendrils or hair that can help increase surface area contact. High-friction material, while not required, can increase an overall grasping strength of the tracks.

The tracks and the compartments thereof need not comprise a single material, and can comprise a composite material, multiple layers having different compositions, or multiple panels/pieces having different compositions. Further, when multiple compartments are used, the compartments need not have the same composition as other compartments or as other portions of the track.

Each compartment surrounds a jamming or other phase change material, and an activation device can be placed in communication with the jamming or other phase change material. Jamming is the physical process by which some materials, such as glasses, foams, coffee grounds, collections of grains, and other complex fluids, become rigid, for example with increasing density. The jamming transition has been proposed as a new type of phase transition, with similarities to a glass transition but very different from the formation of crystalline solids. While a glass transition occurs when the liquid state is cooled, the jamming transition happens for example when density is increased. A crowding of the constituent particles prevents them from exploring phase space, making the aggregate material behave as a solid. In accordance with various embodiments of the present teachings, the jamming material is able to unjam.

Regarding jamming, while many materials experience discrete liquid and solid behavior, granular matter, for example such as coffee grounds, sand, or glass particles, can quickly and easily switch between liquid and solid behavior. When a granular material such as coffee grounds is jammed, such as by vacuum packing, it becomes tightly packed and free volume is too small for the particles to move, leading to a solid-like behavior by the coffee grounds. When the vacuum seal is broken, the coffee grounds can again behave like a liquid as particles flow past one another. This gives a desirable property of selective deformability and rigidity that can be utilized for terrain accommodation by remote vehicle tracks.

In accordance with the present teachings, an exemplary jamming material includes coffee grounds or structurally similar particles in air that are activated by a volume change. In addition to coffee grounds, the following other exemplary granular materials can be used for jamming: one or more of salt, glass beads, and sand can be used as jamming material when the air volume within the compartment is increased/decreased to cause desired jamming behavior; glass beads and water can be used as jamming material when the water volume within the compartment is increased/decreased using an appropriate pump to cause desired jamming behavior.

Other phase change materials can be used in a track compartment in accordance with the present teachings. One such material is a dilatant material such as a combination of cornstarch and water (sometimes referred to as oobleck), which can be activated to a more solid state via application of vibration. A dilatant (also called shear thickening) material is one in which viscosity increases with the rate of shear. The dilatant effect is not completely understood, but is believed to occur when closely-packed particles are combined with enough liquid to fill the gaps between them. At low velocities, the liquid acts as a lubricant, and the dilatant flows easily. At higher velocities, the liquid is unable to fill the gaps created between particles, and friction greatly increases, causing an increase in viscosity.

Other materials that are not phase change materials, but which are contemplated for use in jamming tracks of the present teachings, can include electrorheological (ER) fluids and magnetorheological (MR) fluids. ER fluids are suspensions of extremely fine non-conducting particles (up to, for example, 50 micrometers in diameter) in an electrically insulating fluid. The apparent viscosity of these fluids can change reversibly by an order of up to 100,000 in response to an electrical field. An MR fluid is a suspension of micrometer-sized magnetic particles in a carrier fluid, usually a type of oil. When subjected to a magnetic field, the fluid greatly increases its viscosity, to the point of becoming a viscoelastic solid. The yield stress of the fluid when in its active (“on”) state can be controlled by varying the magnetic field intensity.

Yet another phase change material can include supersaturated sodium acetate solutions that, when heated to around 100° C. and subsequently allowed to cool, become supersaturated. This solution is capable of supercooling to room temperature without forming crystals and then, by application of a small amount of energy such as a mechanical shock, a nucleation center is formed and causes the solution to crystallize into a solid sodium acetate trihydrate. Solidification is reversible through application of heat.

Devices used to actuate the phase change material will vary based on the type of material and its mode of activation. For jamming materials that exhibit change from a solid-like state to a free-flowing state (and vise versa) based on a volume change, a mechanical pump mechanism or diaphragm (e.g., a vacuum biased-diaphragm which works by applying negative pressure to the jamming cavity at rest and is unjammed by depressing the diaphragm) can be employed to cause a volume change and a resulting phase change.

For activating dilatant material, a low voltage, low current miniature vibrating motor can be utilized. The vibrating motor can, for example, operate on a 1-5 VDC motor with an offset weighted shaft, such as those used in cell phones and pagers for a vibrating alert signal. Electrical plates, for example one inside of the compartment and one outside of the compartment, can be used to activate ER material. Magnets located in or near the compartment can be used to activate MR material by creating a magnetic field within the compartment.

### Open Cell Tracks

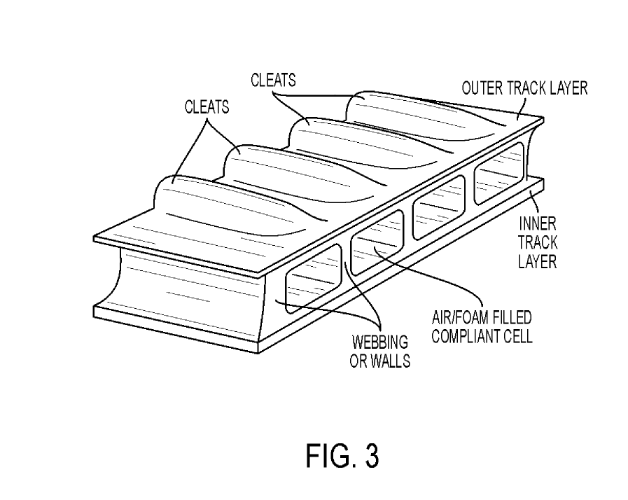

Certain embodiments of the present teaching include modifications to remote vehicle track geometry that can reduce ground pressure, such as a dual-layer track design, an exemplary embodiment of which is illustrated in FIG. 3. Such a dual-layer track can comprise, for example, an inner track layer providing required track tension, and an outer track layer providing an interface with the ground. A series of cells can be provided between the two track layers, the series of cells being defined, for example, by a webbing or walls attaching the inner track layer to the outer track layer. The webbing geometry and cell structure can provide compliance for the outer track layer to deform in response to areas of increased ground pressure. FIG. 3 illustrates a segment of an exemplary dual-layer track having optional cleats extending outwardly therefrom to increase traction.

For a dual-layer track having open cells, the total available suspension travel can be defined by a free length between the inner track layer and the outer track layer. Various compliant web geometries are contemplated for providing an optimal design including high stiffness in shear and low stiffness in compression. These stiffness characteristics can provide maximum contouring of the track to the terrain and maximum transmission of power from the drive wheel to the ground.

### Flap-Cleated Tracks

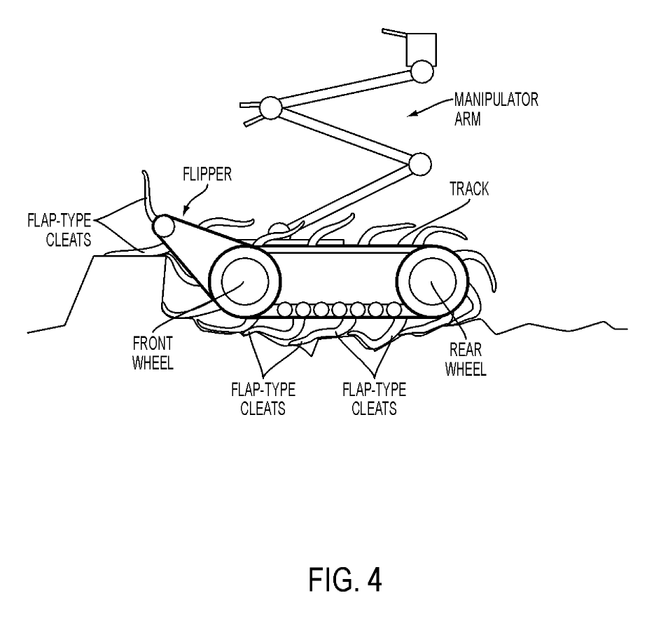

In accordance with various embodiments of the present teachings, another modification to the remote vehicle track geometry to increase a track's ground contact and thereby lower ground pressure is a flap-cleated track system as shown in FIG. 4.

A flap-cleated track system is derived from the concept behind gecko feet, in that the flaps maximize contact surface area to provide maximum adhesion with the ground. In certain embodiments of the present teachings, the increased surface area afforded by the flap-type cleat can be combined with cleats extending outwardly from the flap-type cleats to provide a substantial amount of grip force and weight distribution. Additionally, the flap-cleated tracks would require minimal changes (if any) to the underlying remote vehicle chassis and drive train. The present teachings contemplate selecting a flap-type cleat stiffness that provides suitable conformability, weight distribution, and durability. The surface cleats on the flap-type cleats can be similar to the cleats illustrated in FIG. 3, although are preferably smaller than the cleats illustrated in FIG. 3, and would not necessarily have the same stiffness as the main portion of the flap-type cleats. The remote vehicle flippers can optionally also include flap-type cleats on their tracks, and flap-type-cleats on the remote vehicle flipper tracks may or may not include surface cleats.

### Controls for Active Suspension Systems

Active sensing and both reactive and predictive response to terrain surrounding the remote vehicle can assist in providing decreased ground pressure and increased traction on all terrain types. Implementation of an active suspension requires one or more sensors on the remote vehicle to develop knowledge of the surrounding terrain and the remote vehicle's 3D position, orientation, and velocity. Methods for calculating and tracking a remote vehicle's position, orientation, and velocity are known in the art. The present teachings contemplate understanding the terrain around the remote vehicle using sensor and software technologies as set forth below.

Remote vehicle sensors that can be utilized to understand surrounding terrain include monocular cameras, a stereo vision camera, Flash LIDAR, laser scanning, and ultra wide band (UWB) radar, which can model and map an environment surrounding the remote vehicle. However, presently, each of these sensor types has only been used for mapping the environment for navigation, path planning, and operator situational awareness. The sensors alone, and current uses thereof, lack the ability to predict and monitor underfoot terrain and how it may be changing due to contact with the remote vehicle. In accordance with various embodiments of the present teachings, monitoring of underfoot terrain can be accomplished using downward-facing 3D sensors such as laser scanners, bogie wheel-based pressure sensors, or proximity sensor arrays.

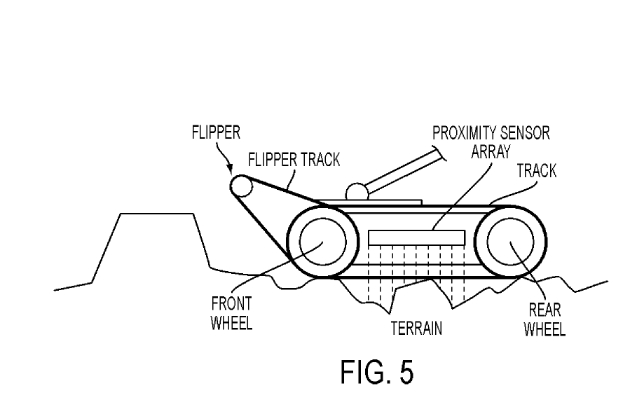

FIG. 5 illustrates an exemplary conceptual model for sensing an underfoot terrain profile using a series of proximity sensors to measure the distance from the underside of the remote vehicle chassis to the terrain directly beside the track, allowing the remote vehicle to reactively adapt its track profile to changing terrain due to remote vehicle travel, slipping, or disturbed obstacles. A more predictive approach can also be employed by modeling the terrain surrounding the remote vehicle. Anticipating the upcoming terrain can enable the remote vehicle to adapt its track profile, flipper position, arm position, and center of balance. Monitoring, mapping, and classifying the surrounding terrain can be accomplished by downward-angled 3D sensors such as laser scanners or Flash LIDAR. Furthermore, underfoot sensing can be combined with terrain monitoring, mapping, and classifying to improve accuracy and update the overall understanding of the surrounding terrain.

### Active Bogie Wheels

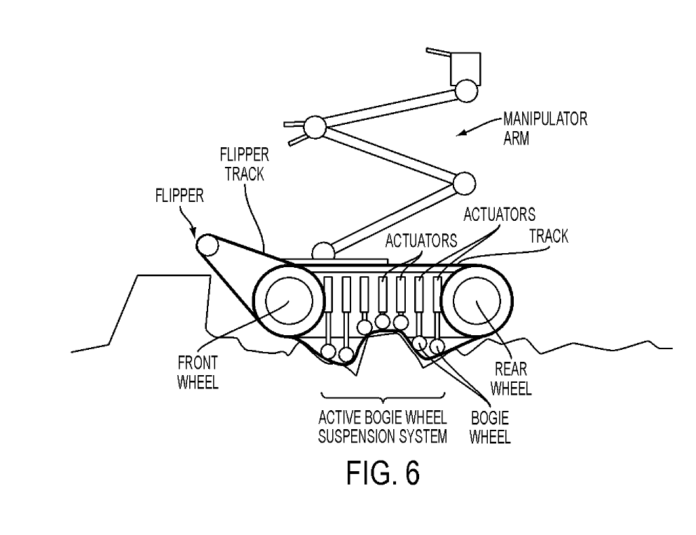

An exemplary embodiment of the present teachings comprising an active bogie wheel suspension can utilize individual actuators on each bogie wheel to press the bogie wheel against the remote vehicle track, thereby changing the track profile beneath the remote vehicle. To contour the remote vehicle tracks to the underlying terrain, the remote vehicle can be equipped with actively controlled bogie wheels capable of responding quickly and accurately to sensed profile changes. A track tensioning system can also be provided. FIG. 6 illustrates an exemplary embodiment of an active bogie wheel suspension system, wherein each bogie wheel is attached to an actuator that is capable of moving the bogie wheel vertically to modify the track support profile. Existing bogie wheel designs only provide support to the track when the bogie wheels are pressed against the track. Certain embodiments of the present teachings additionally provide a captive track guide allowing the bogie wheels to pull the track away from the terrain to create an optimal track profile if desired.

### Shifting the Center of Gravity

Certain existing remote vehicles can shift their center of gravity to allow for increased mobility. U.S. Patent Publication No. 2008/0223630, titled Robotic Vehicle, published Sep. 18, 2008 and filed Aug. 6, 2007, is incorporated by reference herein in its entirety. U.S. Patent Publication No. 2008/0223630 shows and describes, with respect to at least FIG. 9, a device and method for shifting a center-of-gravity of a remote vehicle. A linkage connects a payload deck assembly to a chassis, and is configured to support a payload on the chassis. The linkage has a first end rotatably connected to the chassis at a first pivot, and a second end rotatably connected to the deck at a second pivot. Both of the first and second pivots can include independently controllable pivot drivers operable to rotatably position their corresponding pivots to control both fore-aft position and pitch orientation of the payload deck assembly with respect to the chassis. The first pivot is not necessarily limited by a range of motion of the pivot, but rather by those positions in which the linkage, deck assembly, or payload interfere with part of the remote vehicle such as the chassis or with the ground—which may depend on the character of the ground and pose of the remote vehicle. Accordingly, in another implementation, the sweep of the linkage is limited by the chassis of the remote vehicle, which is configured as small tube element connecting chassis arms. The deck assembly and linkage may sweep between the chassis arms and between the flippers in either direction, and may sweep past a horizontal line defined by one chassis track wheel. The disclosed payload deck assembly, with or without a payload, can be tilted to move the center of gravity of the remote vehicle further in a desired direction.

Independently-controllable pivot drivers can provide both fore-aft position (and a wide sweep range) and pitch orientation of the payload deck assembly with respect to the chassis to selectively displace a center of gravity of the payload deck assembly both forward and rearward of a center of gravity of the chassis. This can provide enhanced mobility to negotiate obstacles.

Rotation of the linkage about its first and second pivots enables selective positioning of a center of gravity or center of mass of the payload deck assembly both fore and aft the front wheel axis as well as both fore and aft of a center of gravity of the chassis. In one implementation, the first pivot of the linkage is located above and forward of the front wheel axis and swings the linkage for displacing the center of gravity of the payload deck assembly to a desired location. Furthermore, when the first end of the linkage is rotatably connected near the front of the chassis, the payload deck assembly is displaceable to an aft-most position in which the payload deck assembly is located within a footprint of the chassis.

Other embodiments of the present teachings contemplate using other center-of-gravity shifting means, for example comprising a four-bar linkage and a motor for a pivot connecting the four-bar linkage to the remote vehicle chassis. A payload is connected atop the four-bar linkage, and the four-bar linkage allows the payload to be kept level as the pivot is driven to shift the payload fore and aft.

Center-of-gravity shifting as described above can be utilized to allow a remote vehicle to, for example, traverse steep slopes and climb stairs. One or more poses can been developed that move the center-of-gravity toward the front of the main drive tracks using a linkage as described above. Existing center-of-gravity shifting actuators can be slow and require the operator to command the remote vehicle into weight-shifting poses. The present teachings contemplate an actively-controlled center-of-gravity shifting payload utilizing a behavior allowing rapid predictive or reactive response to changing terrain. Such an actively controlled payload can increase the ability of the remote vehicle to negotiate a variety of obstacles.

### Independent and Autonomous Flipper Control

Certain existing remote vehicles, such as the iRobot® PackBot®, have commonly actuated tracked flippers. While current fielded systems provide teleoperated control of the flippers, it has been observed that operators may not use the flippers effectively. The addition of autonomous behaviors to control remote vehicle flippers could greatly increase the effectiveness of flipper use. Examples of behaviors that can benefit from autonomous flipper control are autonomous stair climbing and self-righting behaviors.

Other embodiments of the present teachings will be apparent to those skilled in the art from consideration of the specification and practice of the teaching disclosed herein. It is intended that the specification and examples be considered as exemplary only, with a true scope and spirit of the present teachings being indicated by the following claims.

What is claimed is:

1. A tracked remote vehicle configured to provide a uniform ground contact pressure when operating, the tracked remote vehicle comprising:
an active suspension system including one or more of active sensing with both reactive and predictive responses to the terrain, active bogie wheels, a center-of-gravity shifting payload or device, and independent autonomous flipper control.

2. The tracked remote vehicle of claim 1, wherein the active suspension system comprises one or more sensors on the remote vehicle developing knowledge of the surrounding terrain using sensor and software technologies.

3. The tracked remote vehicle of claim 2, wherein the one or more sensors comprise one or more of monocular cameras, a stereo vision camera, Flash LIDAR, laser scanning, and ultra wide band (UWB) radar.

4. The tracked remote vehicle of claim 1, wherein the active suspension system comprises downward-facing 3D sensors including one or more of a laser scanner, a bogie wheel-based pressure sensor, and a proximity sensor configured to monitor terrain under the remote vehicle.

5. The tracked remote vehicle of claim 4, wherein the proximity sensor is configured to measure a distance from an underside of a chassis of the remote vehicle to the terrain directly beside a track of the remote vehicle, allowing the remote vehicle to reactively adapt its track profile to changing terrain.

6. The tracked remote vehicle of claim 1, wherein the active suspension system comprises active bogie wheels including individual actuators on each bogie wheel that press the bogie wheel against the remote vehicle track, thereby changing a track profile beneath the remote vehicle.

7. The tracked remote vehicle of claim 6, further comprising a captive track guide allowing the bogie wheels to pull the track away from the terrain to create an optimal track profile.

8. A tracked remote vehicle configured to provide a uniform ground contact pressure when operating, the tracked remote vehicle comprising:
a passive suspension system to enhance track contact over uneven ground and including one or more of a suspended bogie wheels, a compliant bogie strip, jamming tracks, open track cells, and flap-cleated tracks.

9. The tracked remote vehicle of claim 8, wherein the passive suspension system comprises suspended bogie wheels, and a sideplate and battery ports of the remote vehicle are relocated, and compliance is added to a rear idler wheel to maintain required track tension while allowing for terrain contouring for the suspended bogie wheels, which are suspended by mechanical linkages with spring dampers to provide maximum travel and shock absorption.

10. The tracked remote vehicle of claim 8, wherein the passive suspension system comprises a compliant bogie strip that is implemented without mechanical linkages, and is mounted on a compliant one-piece bogie strip engaging a bottom portion of the track.

11. The tracked remote vehicle of claim 10, wherein bogie wheels are mounted to the compliant bogie trip via mounting arms that determine compliance of the bogie strip.

12. The tracked remote vehicle of claim 8, wherein the passive suspension system comprises jamming tracks, each jamming track comprising compartments containing a jamming material.

13. The tracked remote vehicle of claim 12, wherein the material comprising the compartments is elastic or flexible, having a strength sufficient to carry the remote vehicle across a variety of terrains.

14. The tracked remote vehicle of claim 8, wherein the passive suspension system comprises open track cells having a dual-layer track including an inner track layer providing required track tension, an outer track layer providing an interface with the ground, and a series of cells being defined by a webbing or walls attaching the inner track layer to the outer track layer.

15. The tracked remote vehicle of claim 8, wherein the passive suspension system comprises flap-cleated tracks including flap-type cleats that increase a surface area of the remote vehicle tracks.

16. The tracked remote vehicle of claim 15, wherein the increased surface area afforded by the flap-type cleat can be combined with cleats extending outwardly from the flap-type cleats.

17. The tracked remote vehicle of claim 15, wherein the flap-type cleats comprise a material having a stiffness that provides suitable conformability, weight distribution, and durability.

18. A method for providing a uniform ground contact pressure when operating a tracked remote vehicle, the method comprising:
sensing the terrain below the remote vehicle using a series of proximity sensors that are configured to measure a distance from an underside of a chassis of the remote vehicle to the terrain directly beside a track of the remote vehicle;
monitoring, mapping, and classifying an upcoming terrain; and
adapting the remote vehicle's track profile, flipper position, arm position, and center of balance based on the upcoming terrain.

19. The method of claim 18, wherein monitoring, mapping, and classifying the surrounding terrain can be accomplished by downward-angled 3D sensors such as laser scanners or Flash LIDAR.

20. The method of claim 18, further comprising combining information regarding the sensed terrain below the remote vehicle with information regarding the upcoming terrain to improve accuracy of the vehicle adapted track profile.
